(19) United States
(12) Patent Application Publication
(10) Pub. No.: US 2023/0317985 A1
(43) Pub. Date: Oct. 5, 2023

(54) METHOD FOR OPERATING A SOLID OXIDE FUEL CELL DEVICE, THE SOLID OXIDE FUEL CELL DEVICE AND A MOTOR VEHICLE OUTFITTED WITH SUCH

(71) Applicants: AUDI AG, Ingolstadt (DE); VOLKSWAGEN AG, Wolfsburg (DE)

(72) Inventor: Christian LUCAS, Braunschweig (DE)

(21) Appl. No.: 18/001,793

(22) PCT Filed: Sep. 13, 2021
(86) PCT No.: PCT/EP2021/075031

§ 371 Date: Dec. 14, 2022

(30) Foreign Application Priority Data
Sep. 16, 2020 (DE) 10 2020 124 072.4

(51) Int. Cl. H01M 8/04291; H01M 8/04014; H01M 8/04082; H01M 8/04701; H01M 8/04828

(52) U.S. Cl. CPC H01M 8/04291; H01M 8/04014; H01M 8/04216; H01M 8/04716; H01M 8/04843; H01M 2250/20

(57) ABSTRACT

A method for operating a solid oxide fuel cell device is provided, which includes:
using waste heat arising during the operation of the solid oxide fuel cell to produce cold by means of a refrigeration machine integrated in a refrigeration circuit for cooling of the exhaust gas at the anode side,
condensing the water in the exhaust gas arising at the anode side with the aid of the refrigeration machine by a first water condenser,
separating the water by a water separator,
compressing the CO₂ exhaust gas flow at the anode side, wherein the cooling power produced by the refrigeration machine is used for cooling of the CO₂ exhaust gas flow, and
storing the compressed CO₂ in a CO₂ storage.

A solid oxide fuel cell device and a motor vehicle having a solid oxide fuel cell device are also provided.

### BACKGROUND

### Technical Field

Embodiments of the invention relate to a method for operating a solid oxide fuel cell device.

Embodiments of the invention furthermore relate to a solid oxide fuel cell device and a motor vehicle having a solid oxide fuel cell device.

### Description of the Related Art

Fuel cells serve for providing electric energy in a chemical reaction between a hydrogen-containing fuel and an oxygen-containing oxidizing agent, generally air. In a solid oxide fuel cell (SOFC) there is an electrolyte layer of a solid material, giving the cell its name, such as ceramic yttrium-doped zirconium dioxide, which is capable of conducting oxygen atoms, while electrons are not conducted. The electrolyte layer is contained between two electrode layers, namely, the cathode layer, to which air is supplied, and the anode layer, which is supplied with the fuel, which can be formed by H₂, CO, CH₄, C₃H₈ or similar hydrocarbons. If air is led through the cathode layer to the electrolyte layer, the oxygen takes up two electrons and the resulting oxygen ions O²⁻ move through the electrolyte layer to the anode layer, where the oxygen ions react with the fuel to form water and CO₂. At the cathode side, the following reaction occurs: ½O₂+2e⁻→2O²⁻ (reduction/electron uptake). At the anode, the following reactions occur: H₂+O²⁻→H₂O+2e⁻ and CO+O²⁻→CO₂+2e⁻ (oxidation/electron surrender).

Solid oxide fuel cells require high temperatures, usually over 700° C., at which they are operated, so that the use of the term high-temperature fuel cell is also customary.

When using CH₄ or another hydrocarbon as the fuel, CO₂ emissions are formed. These emissions can be stored in a CO₂ storage and used to regenerate methane in a power-to-gas process during the use of the solid oxide fuel cell device in a motor vehicle, such as when refueling. But since the anode exhaust gas does not consist solely of CO₂, but also some degree of water, it is first necessary to condense and separate the water in a condenser. By separating the water, a mass fraction of CO₂ of more than 90% is achieved. Furthermore, it is possible for the anode exhaust gas to be cooled by heat exchangers. The condenser can be cooled by means of a cooling circuit. This cooling circuit takes up the heat contained in the anode exhaust gas and gives it off to the surroundings. But in this case the possible temperature minimum of the anode exhaust gas downstream from the condenser is dependent on the ambient temperature. At higher temperatures, consequently, the water contained in the anode exhaust gas is not fully condensed. This residual water is condensed by the elevated pressure in the following compressor stages and thus damages the compressor.

### BRIEF SUMMARY

Some embodiments provide a method making it possible to cool down the exhaust gas flow on the anode side to below the ambient temperature, so that the water condensation is improved. Some embodiments provide an improved solid oxide fuel cell device and a more efficient motor vehicle having a solid oxide fuel cell device.

Some embodiments include a method in which the anode exhaust gas can be actively cooled to below the ambient temperature without additional input of external energy, simply by utilizing the waste heat produced during the operation of the solid oxide fuel cell device, so that the condensation of the water is improved and the at least one compressor is better protected. Furthermore, the water in the exhaust gas arising at the anode side may be fully condensed by means of a first temperature level of a first stage of the refrigeration circuit, and the CO₂ in the exhaust gas arising at the anode side may be liquefied and thus further compressed after a first and/or a second compressor stage in a second stage of the refrigeration circuit by means of a second temperature level, which is lower than that of the first stage. Thanks to the liquefaction of the CO₂, larger compression ratios are achieved with lower compressor power at the same time.

Furthermore, at least one valve may be arranged in the refrigeration circuit to supply at least one gas cooler, and the power for cooling the CO₂ may be adjusted by the at least one valve.

Furthermore, a solid oxide fuel cell device is proposed, having a fuel cell stack with at least one fuel cell, a methane tank, a CO₂ storage, a water separator, at least one compressor and a refrigeration machine integrated in a refrigeration circuit for cooling the exhaust gas on the anode side. Thanks to the cooling of the exhaust gas on the anode side, a more effective condensation of the water fraction is achieved, so that the residual water content in the anode exhaust gas is reduced, thereby protecting the compressor units situated downstream from the water separator against water damage. The lowered temperature also affords the advantage that the compression ratio can be increased.

The refrigeration machine may be formed by an absorption refrigeration system to produce cold from the waste heat on the cathode side in a refrigeration circuit. Absorption refrigeration systems are distinguished by an efficient utilization of waste heat and little fault vulnerability.

Furthermore, it is possible for the refrigeration machine to be formed by a thermocompressor having at least one jet pump to produce cold from the waste heat in a refrigeration circuit. A thermocompressor is also distinguished by little fault vulnerability and thus by a long-lived operation. It also has a high operating safety.

It is also possible to use the energy of the exhaust gas to operate the refrigeration circuit. At first, the anode exhaust gas is cooled down to ambient temperature with the coolant in a first water condenser, and then it is further cooled down by means of the refrigerant from the refrigeration circuit by a second water condenser. Thanks to these two water condenser stages, the refrigerating power of the refrigeration circuit can be reduced, so that the solid oxide fuel cell device can be operated more efficiently. Design space within the solid oxide fuel cell device can be economized in that the two water condensers can also be combined in one structural component.

At least one compressor may be situated downstream from the water separator and a gas cooler may be situated downstream from the at least one compressor, the at least one gas cooler being connected to the refrigeration circuit. In this case, the CO₂ exhaust gas flow after each compressor stage is at first cooled by the coolant, which may consist of water or glycol, and then cooled again by the refrigerant from the refrigeration circuit. Thanks to this layout, the compressor inlet temperature of the CO₂ exhaust gas flow can be reduced and thus the distance from the maximum compressor outlet temperature can be increased. Thus, a greater compression is made possible. If multiple compressor stages are used, the compression ratio can be increased again by the repeated cooling after the compression. Thanks to the more efficient working of the individual compressor stages, the work of the compressor can be further reduced. It is also possible to economize on compressor stages thanks to this more efficient working, so that less design space is needed.

For a motor vehicle having such a solid oxide fuel cell device, the above mentioned benefits and effects apply equally.

The features and combinations of features mentioned above in the description and the features and combinations of features mentioned below in the description of the figures and/or shown solely in the figures can be used not only in the particular indicated combination, but also in other combinations or standing alone. Thus, embodiments which are not shown explicitly or explained in the figures, yet which can be created and emerge from separated combinations of features from the explained embodiments should be viewed as also being disclosed and encompassed by the present disclosure.

### BRIEF DESCRIPTION OF THE SEVERAL VIEWS OF THE DRAWINGS

Further benefits, features and details will emerge from the claims, the following description of embodiments, and the drawings.

FIG. 1 shows a schematic representation of a solid oxide fuel cell device with gas coolers connected to a refrigeration machine.

FIG. 2 shows a schematic representation of a solid oxide fuel cell device with a two-stage refrigeration circuit.

### DETAILED DESCRIPTION

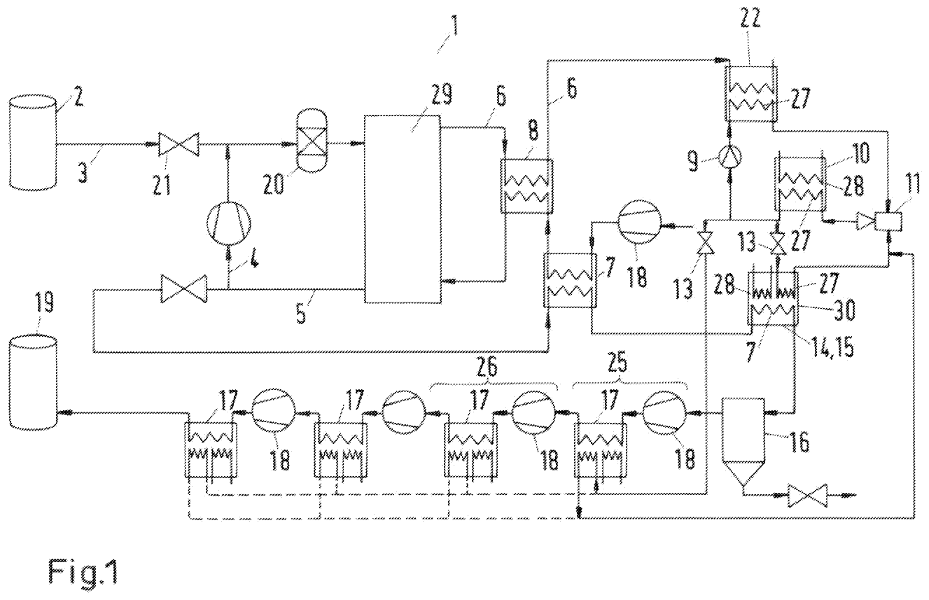

FIG. 1 shows a schematic representation of a solid oxide fuel cell device 1 with an integrated refrigeration machine. Via a methane tank 2, methane as the fuel is taken by means of a fuel line 3 to the fuel cell stack 29. During the chemical fuel cell reaction, oxygen is produced at the cathode side, while water and carbon dioxide are prevalent as exhaust gas on the anode side. Unreacted fuel is recirculated through a recirculation line. The remaining anode exhaust gas is taken by an anode exhaust gas line 5 to a first heat exchanger 7, which further heats the compressed and heated air provided by a compressor 18 on the cathode side. The cathode exhaust gas is taken by a cathode exhaust gas line 6 to a second heat exchanger 8, which further heats the air upstream from the fuel cell stack 29, i.e., it uses the waste heat on the cathode side to control the temperature of the fresh air. The temperature of the cathode exhaust gas after going through the second heat exchanger 8 is still over 300° C. and it is used as the heat source 22 for the refrigeration machine. The refrigeration machine can be formed by either an absorption refrigeration system or a thermocompressor (FIG. 1). In the thermocompressor, the refrigerant 27 is condensed in a condenser 10, after which a portion of the refrigerant 27 is cooled down by throttling by means of a valve 13. In an evaporator 30, the refrigerant 27 is evaporated, thereby providing the cooling power. Next, the refrigerant is again compressed in the jet pump 11. The other portion of the liquid refrigerant 27 is compressed by means of a pump 9 downstream from the condenser 10 and then heated by the waste heat of the fuel cell stack 29. The refrigerant 27 is then expanded in the jet nozzle of the jet pump 11 and serves as the driving energy for the intake mass flow.

With such a solid oxide fuel cell device 1 it is possible to carry out the method described herein for the operation of the solid oxide fuel cell device 1, involving the following steps:
using the waste heat arising during the operation of the solid oxide fuel cell, especially on the cathode side, to produce cold by means of a refrigeration machine integrated in a refrigeration circuit for cooling of the exhaust gas at the anode side, and this until it falls below ambient temperature,
condensation of the water in the exhaust gas arising at the anode side with the aid of the refrigeration machine by a first water condenser 14,
separating the water by a water separator 16,
compressing the CO₂ exhaust gas flow at the anode side, wherein the cooling power produced by the refrigeration machine is used for cooling of the CO₂ exhaust gas flow,
storing of the compressed CO₂ in a CO₂ storage 19.

It is evident from FIG. 1 that a further valve 13 is situated downstream from the condenser 10 in order to supply a least one gas cooler 17 with the refrigerant 27. By installing at least one of these valves 13, it is possible to control the refrigerating power for the cooling of the CO₂ flow. By using a second water condenser 15, which can also be combined with the first water condenser 14 to form a structural component, the anode exhaust gas can be cooled down in a first step by the first water condenser 14 and the coolant 28 to ambient temperature. In a second step, the anode exhaust gas is further cooled down by the refrigerant 27 in the second water condenser 15, so that the residual water is also still condensed. After the separating of the water from the anode exhaust gas, the remaining CO₂ gas flow is compressed by multiple compressor stages 25, 26. Between the compressor stages 25, 26, the CO₂ gas flow is cooled by gas coolers 17, which are connected to the refrigeration circuit of the refrigeration machine, so that the compression ratio is increased, and thus the compressor work of the individual compressor stages 25, 26 and/or the number of the compressor stages 25, 26 can be reduced.

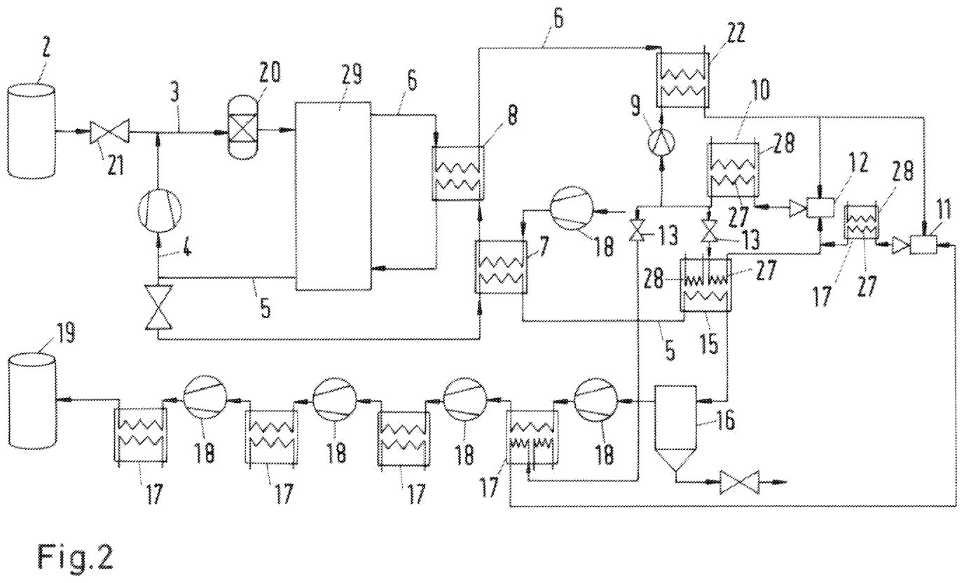

FIG. 2 shows a schematic representation of a solid oxide fuel cell device 1 having a two-stage refrigeration circuit. Thanks to this two-stage refrigeration circuit it is possible for the water in the exhaust gas produced on the anode side to be fully condensed by means of a first temperature level of a first stage of the refrigeration circuit, and for the CO₂ in the exhaust gas produced on the anode side to be liquefied and thus further condensed in a second stage of the refrigeration circuit by means of a second temperature level, which is less than that of the first stage, after a first and/or a second compressor stage 25, 26. In this way, larger compression ratios are achieved at lower compressor power, so that compressor stages 25, 26 can be economized if necessary. Two jet pumps 11, 12 are required for the two-stage refrigeration circuit. The first jet pump 11 compresses the refrigerant 27 from the lower evaporation temperature level to the pressure level of the second water condenser 15. After this, the refrigerant 27 is cooled in a heat exchanger 7 and then further compressed in the second jet pump 12.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a solid oxide fuel cell device, comprising:
using waste heat arising during the operation of the solid oxide fuel cell to produce cold using a refrigeration machine integrated in a refrigeration circuit for cooling of the exhaust gas at the anode side;
condensing water in the exhaust gas at the anode side using the refrigeration machine and a first water condenser;
separating the water using a water separator;
compressing the CO₂ exhaust gas flow at the anode side, wherein a cooling power produced by the refrigeration machine is used for cooling the CO₂ exhaust gas flow; and
storing the compressed CO₂ in a CO₂ storage.

2. The method according to claim 1, wherein the water in the exhaust gas at the anode side is fully condensed by a first temperature level of a first stage of the refrigeration circuit, and the CO₂ in the exhaust gas at the anode side is liquefied and thus further compressed after a first and/or a second compressor stage in a second stage of the refrigeration circuit by a second temperature level, which is lower than that of the first stage.

3. The method according to claim 1, wherein at least one valve is arranged in the refrigeration circuit to supply at least one gas cooler, and the power is adjusted by the at least one valve.

4. A solid oxide fuel cell device, comprising:
a fuel cell stack with at least one fuel cell;
a methane tank;
a CO₂ storage;
a water separator;
at least one compressor; and
a refrigeration machine integrated in a refrigeration circuit for cooling an exhaust gas on an anode side.

5. The solid oxide fuel cell device according to claim 4, wherein the refrigeration machine is formed by an absorption refrigeration system to produce cold from the waste heat on the cathode side in the refrigeration circuit.

6. The solid oxide fuel cell device according to claim 4, wherein the refrigeration machine is formed by a thermocompressor having at least one jet pump to produce cold from the waste heat on the cathode side in the refrigeration circuit.

7. The solid oxide fuel cell device according to claim 6, wherein a first water condenser and second water condenser are arranged in the refrigeration circuit.

8. The solid oxide fuel cell device according to claim 7, wherein the two water condensers are combined in one structural component.

9. The solid oxide fuel cell device according to claim 4, wherein at least one compressor is situated downstream from the water separator and a gas cooler is situated downstream from the at least one compressor, the at least one gas cooler being connected to the refrigeration circuit.

10. A motor vehicle having a solid oxide fuel cell device according to claim 4.
